(19) United States
(12) Patent Application Publication
(10) Pub. No.: US 2004/0137771 A1
(43) Pub. Date: Jul. 15, 2004

(54) Remakeable connector arrangement

(76) Inventor: Jens Schumacher, Duisburg (DE)

Correspondence Address: PROSKAUER ROSE LLP, PATENT DEPARTMENT, 1585 BROADWAY, NEW YORK, NY, 10036-8299, US

(21) Appl. No.: 10/473,924

(22) PCT Filed: Dec. 18, 2002
(86) PCT No.: PCT/EP02/14437

(30) Foreign Application Priority Data
Feb. 7, 2002 (DE) 102 05 131.3
May 7, 2002 (DE) 102 20 475.6

(51) Int. Cl. H01R 25/00; H01M 2/30

(52) U.S. Cl. 439/121; 429/178; 429/121

(57) ABSTRACT

The invention relates to a remakeable connector arrangement (1), in particular for application in motor vehicles, for the connection of high-current contact elements (4, 5), in particular battery poles and clamps. At least one spring connector element (2) is arranged between a sleeved contact element (5) and a pin-shaped contact element (4) which may be introduced into the former and is embodied as a helical spring connected at the ends thereof to form a ring. A remakeable connector arrangement is thus achieved which guarantees a permanently improved contact between the both contact elements (4, 5) in a simple manner. The invention further relates to a corresponding spring connector element (2) and application possibilities thereof.

The invention relates to a re-contactable connection arrangement, in particular for use in motor vehicles, for connecting high-current carrying contact elements, in particular battery poles and battery terminals. Furthermore, the invention relates to a resilient connection element as well as to application options thereof.

In the high-current segment, here are many ways of establishing connections between contact elements. In particular for applications in motor vehicles and in this field especially where vehicle batteries are concerned, it is important that the connections are such that they can be unplugged and plugged together again, i.e. that they are re-contactable, without major effort.

Existing high-current contacts generate a connection between two contact elements as a rule by means of pre-tensioned spring elements, e.g. lamellar springs or helical springs, acting in axial direction. The spring elements form part of one of the two contact elements. In the motor vehicle sector, connections between battery terminals and battery poles are based on a solution involving a screw-type connection in which the terminal is attached to the battery pole by means of a screw-type fitting. In both cases the aim is to generate the greatest possible contact surface and contact force between the contact elements, e.g. between the battery terminal and the battery pole, so as to keep the transition resistance as low as possible.

Systems where pre-tensioned spring elements are provided between the contact elements are associated with a disadvantage in that over time there is a gradual voltage drop and thus a gradual increase in transition resistance. The same also applies to systems which are based on a simple screw-type solution. The latter are associated with a disadvantage in that as a result of the very considerable surface pressure, the metal, and in particular the lead of the pole, starts to flow. As a result, the clamping force, which initially was very considerable, gradually decreases over time. This, too, results in an increase in the transition resistance.

In contrast to the above, it is the object of the invention to improve a re-contactable connection arrangement of the type mentioned in the introduction to the effect that a permanently improved contact between the contact elements is ensured in a simple way.

According to the invention, this object is met by the design of the generic re-contactable connection arrangement with the features of the characterising part of claim 1.

The invention features the arrangement of a special resilient connection element which is placed between a pin-shaped contact element and a socket-shaped connection element. The connection element is a radial spring which is a helical spring whose ends are connected so that the spring forms a ring. When after installation, i.e. after plugging together, the pin-shaped contact element is in the inserted position in the socket-shaped contact element, the resilient connection element is arranged such that its inside touches the pin-shaped contact element and its outside touches the socket-shaped contact element, thus making it possible for an electrical contact to be established. The number of the contact positions between the socket-shaped contact element and the pin-shaped contact element is a result of the internal diameter and the external diameter respectively, the coil width, the wire diameter as well as the axial pitch of the spring of the ring-shaped resilient connection elements. The effective cross-sectional area for current transmission consists of the wire diameter multiplied by the number of contact positions.

By way of the connection arrangement according to the invention, high power, i.e. high current or high voltage, can be transmitted continuously. Furthermore, it also ensures simple installation and deinstallation, and thus simple contacting and de-contacting, without the use of any tools. It is a particular feature of the invention that the resilient connection element maintains its pre-set tension at an almost constant level, and that consequently the transition resistance is kept permanently low. Furthermore, the multitude of windings and the associated multitude of contact points between the resilient connection element and the two contact elements overall create a large contact surface.

To ensure optimum contact between the two contact elements by way of the resilient connection element, the external diameter of the resilient element in its non-compressed or relaxed state, i.e. in the state before it is plugged together, should be larger than the diameter of the pin-shaped contact element. This ensures optimal contact in the installed state, with very considerable contact force being exerted between the outside of the resilient connection element and the inside of the socket-shaped contact element. Furthermore, the resilient connection element should be compressible in radial direction, i.e. in the direction of the pin-shaped contact element, so that the inside of the resilient connection element, too, establishes reliable contact with the pin-shaped contact element. According to a preferred embodiment of the connection arrangement according to the invention, the inside of the socket-shaped contact element comprises at least one fully circumferential groove. Before the two contact elements are plugged together, the ring-shaped resilient connection element can then be inserted into this groove, so that said resilient connection element is compressed as soon as the pin-shaped contact element is inserted, in this way providing an optimal connection between the two contact elements.

In a further preferred embodiment, the outside of the pin-shaped contact element comprises at least one fully circumferential groove, so that, as an alternative to the previously described embodiment, the resilient connection element is first fixed to the pin-shaped contact element as a result of the groove, and subsequently, these two components are inserted into the socket-shaped contact element as a unit.

However, it is not only imaginable that only one of the contact elements comprises a groove; instead, each contact element can comprise a groove, wherein, in the installed state, the two grooves are facing each other, thus serving as the seat of a resilient connection element. The respective opposite grooves can be of different depth. This depends on whether, before the contact elements are plugged together, the resilient connection element forms a unit either with the pin-shaped contact element, or with the socket-shaped contact element. During deinstallation or de-contacting, the resilient element remains caught on or in that contact element which comprises the deeper groove, so that, for example during abrupt unplugging of the contact elements, said resilient element is not easily lost. The base of the grooves can either be curved or angular in cross-section. However, any other shapes are also imaginable. In the final analysis, it is only important that the best possible contact between the respective contact element and the windings of the resilient connection element is ensured.

Apart from ensuring optimum contact, the grooves and the resilient connection element, which in the installed state is situated in said grooves, also ensure defined fixed seating, in axial direction, of the two contact elements. Axial forces can be set in a constructive way by selecting the material, the number of windings, the height and width of the individual winding, etc. This applies in particular if in the installed state two corresponding grooves face each other.

However, a variant is also imaginable in which no grooves are necessary on the pin side, while axial fixation of the contact elements in relation to one another is nevertheless ensured. To this effect, the pin-shaped contact element is of conical shape. Contacting on a conical pole then becomes possible by defined pre-tensioning in the direction of the cone ratio.

As already mentioned above, the largest possible contact surface is crucial in any connection of contact elements. The more windings of the resilient connection elements and thus contacts with the contact elements, the greater is the total contact surface. Ideally, the arrangement is such that each winding of the resilient connection element in the installed state touches both the socket-shaped contact element and the pin-shaped contact element. Correspondingly, the contact surface becomes larger still if several resilient connection elements are used. The various connection elements can be of identical diameter or of different diameter.

According to a further preferred embodiment, sealing elements, e.g. sealing rings, silicon sealing compound, etc. can be put in place in the outer region, so as to provide any sealing characteristics that may be required. As is the case with the resilient connection element, said sealing elements can also be fixed in grooves so that they are not displaced during installation or deinstallation.

In a variant of the invention, proper seating of the contact elements can be indicated by way of an additionally provided visual indicator device, e.g. by way of a suitable lever connection or a button mechanism. In this way, the user or installing technician knows already at the time of plug-in whether the end position has already been reached or whether the pin-shaped contact element needs to be pushed still further into the socket-shaped contact element. Furthermore, this device, i.e. the lever connection or the button mechanism, can also be used for easier deinstallation.

According to yet another variant, a device for preventing an electric arc can be provided. In particular when installing or deinstalling battery pole connections, especially in the case of 42 volt batteries, an electric arc can be generated which can leave components damaged or cause injury to the user. In order to prevent such electric arcs, a switch can be provided, in particular at the top of the socket-shaped contact element, with said switch, in the installed state, touching the face of the pin-shaped contact element, thus providing an electric contact. In order to separate the plugged-together, i.e. the installed, contact elements, thus undoing the connection, axial displacement of the two contact elements relative to each other is necessary. Already right at the beginning of the displacement, the switch becomes detached from the face of the pin-shaped contact element and thus detects the start of the displacement process and thus the start of axial de-contacting. At this point in time, the contact between the two contact elements by way of the resilient connection element still exists. However, the switch which detects de-contacting immediately generates a signal for separate switching-off, with said switching-off interrupting the current path. As a result of this, no arc can occur during continuation of the displacement movement for undoing the contact elements. However, it is also possible to provide a high-current element, in particular a graphite ring, to detect axial de-contacting and to generate a separate switch-off signal, wherein said high-current element, in the installed state, touches one of the contact elements and consequently can establish electrical contact, and wherein axial de-contacting is detectable by way of said high-current element.

The invention further relates to a resilient connection element for connecting contact elements, with said resilient connection element being a helical spring whose ends are connected so that it forms a ring, which ring can also be radially compressible. In a connection arrangement between two contact elements, e.g. between battery terminal and battery pole, such a resilient connection element can be used both as a retention-safeguarding element and as a current transmission element. Both functions, i.e. axial fixation or retention safeguarding of the pin-shaped contact element within the socket-shaped contact element, in particular, however, establishment of a contact between the two contact elements, have already been described in the paragraphs above.

Below, the invention is explained in more detail by means of a drawing which shows some exemplary embodiments, as follows:

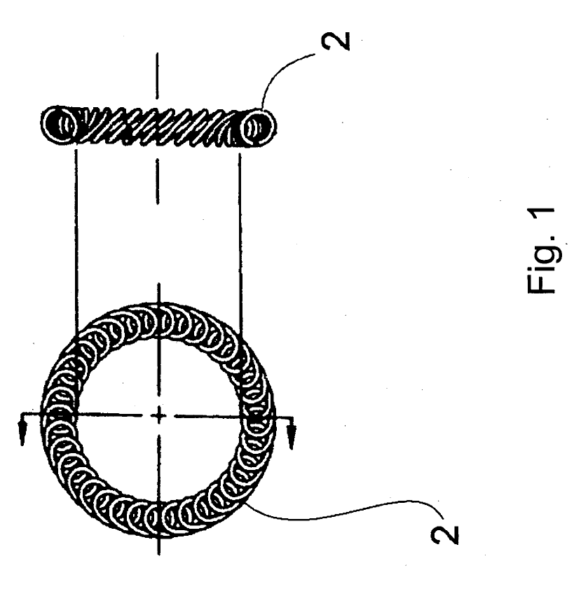

FIG. 1 an embodiment of the resilient connection element according to the invention;

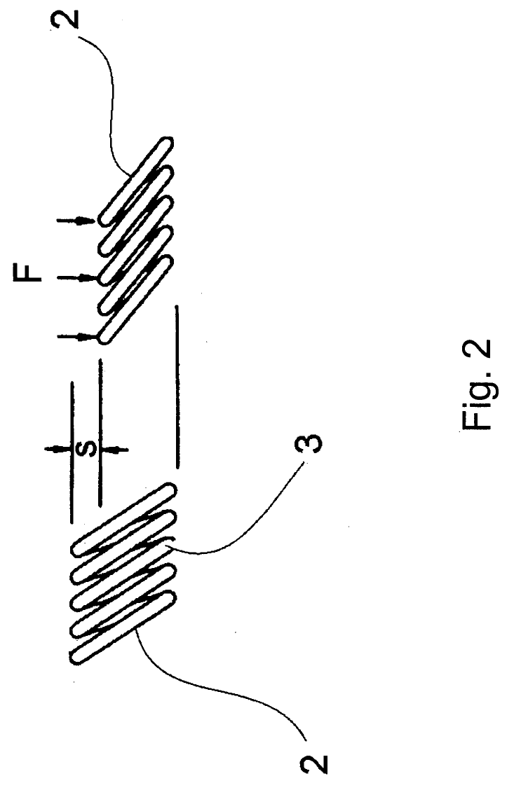

FIG. 2 a resilient connection element in the non-tensioned and in the pre-tensioned state;

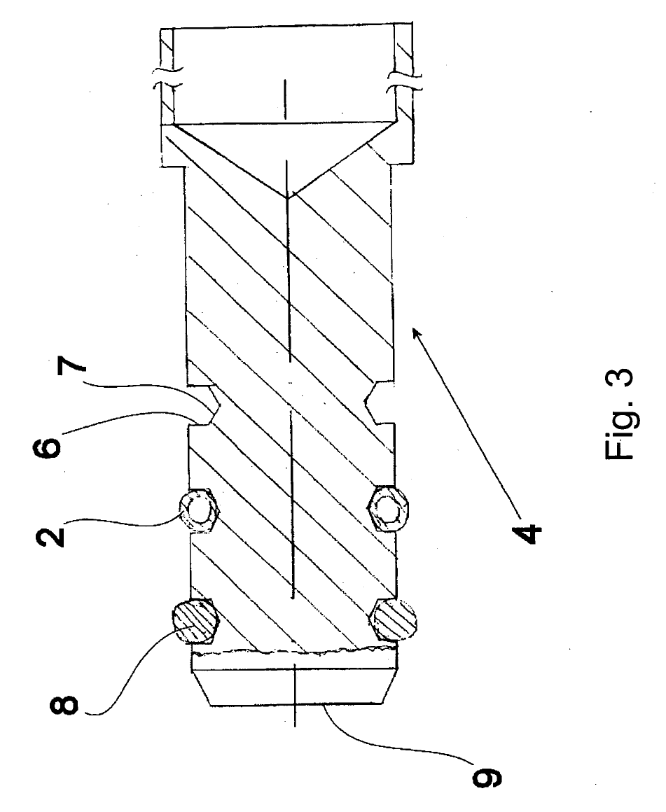

FIG. 3 a longitudinal section of an embodiment of a pin-shaped contact element; and

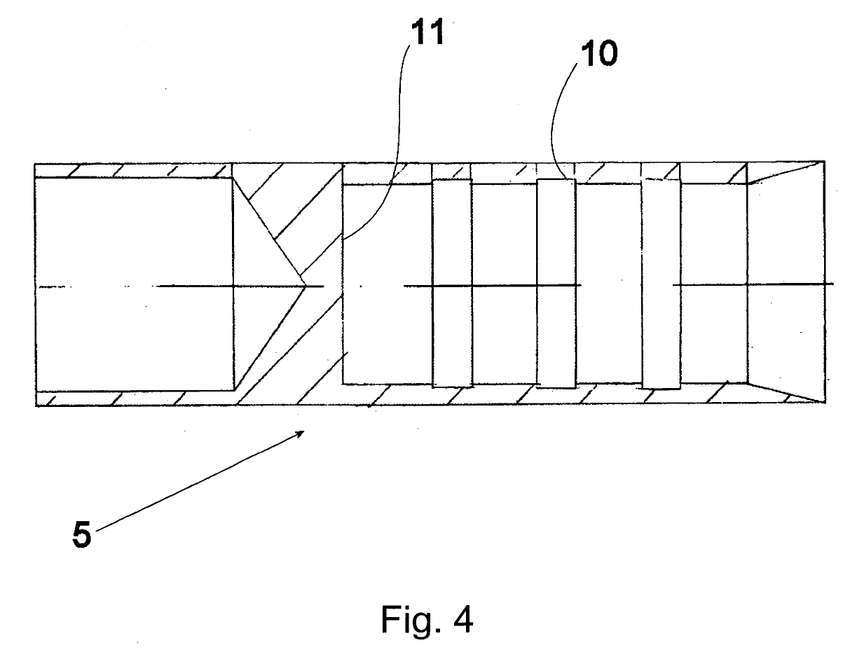

FIG. 4 a longitudinal section of a socket-shaped contact element which corresponds to the contact element in FIG. 3.

FIG. 1 shows an embodiment of a resilient connection element 2, as is arranged between a pin-shaped contact element 4 and a socket-shaped contact element 5 so as to electrically interconnect the contact elements 4 and 5. In the right-hand part of FIG. 1, the resilient connection element 2 is shown in sectional view along the sectional line shown in the left-hand part of FIG. 1. It is clearly shown that the connection element 2 comprises a helical spring whose two ends are connected so that the helical spring forms a ring. In the installed state, i.e. if the pin-shaped contact element 4 is inserted in the socket-shaped contact element 5, the outside of the ring-shaped connection element 2 establishes electrical contact with the socket-shaped contact element 5 by way of its windings 3, while the inside of the ring-shaped connection element 2 establishes electrical contact with the pin-shaped contact element 4 by way of its windings 3.

FIG. 2 shows the change in shape of the resilient connection element 2 when it is arranged between the two contact elements 4 and 5 which have been plugged together. The left-hand part of FIG. 2 shows a section of the connection element 2 in its non-compressed form. There is a relatively large space between the individual windings 3 of the connection element 2. In comparison to this, the right-hand part of FIG. 2 shows the connection element 2 in its compressed state, i.e. in the installed state. Since in this state, a force F acts from the contact element to the resilient connection element 2, which force F compresses said connection element 2 in radial direction, the winding height is correspondingly reduced by an amount s. Consequently, the distance between the individual windings 3 is clearly shorter than is the case in the non-compressed state.

Apart from the previously described resilient connection element 2, the re-contactable connection arrangement 1 comprises a pin-shaped contact element 4 and a socket-shaped contact element 5. FIG. 3 shows a longitudinal section of the pin-shaped contact element 4. The contact element 4 comprises three fully circumferential grooves 6 whose base 7 is angle-shaped in cross section. In the left groove, a sealing element in the form of an O-shaped sealing ring 8 is arranged which is intended for sealing off the space between the contact elements 4 and 5 from the environment, especially from moisture. The middle groove contains the resilient connection element 2, which is shown in detail in FIG. 1, with said resilient connection element 2 being provided to establish the electrical contact between the pin-shaped contact element 4 and the socket-shaped contact element 5. The external diameter of the connection element 2, which in the present example has not yet been compressed, is larger than the diameter of the pin-shaped contact element 4. In this way, in the installed state, the socket-shaped contact element 5 can transfer a certain force F to the connection element 2, and can thus generate a tension which ensures that each of the windings 3 of the connection element 2 establishes optimum contact with both contact elements 4 and 5.

FIG. 4 shows the socket-shaped contact element 5 into which the pin-shaped contact element 4 together with the connection element 2 and the sealing ring 8 (both in place) are inserted in order to establish electrical contact. When the two contact elements 4 and 5 are plugged together, the sealing ring 8 is in the left of the three depicted grooves 10 of the contact element 5. The ring-shaped connection element 2 is then in the middle groove. Also shown is the straight base 7 of the grooves on the inside of the socket-shaped contact element 5, with the grooves being significantly less deep than the grooves 6 in the pin-shaped contact element 4. This ensures that during deinstallation, both the sealing ring 8 and the connection element 2 remain fixed on the pin-shaped contact element 4 rather than being able to become caught in the inside of the socket-shaped contact element 5 or, worse still, to be lost.

A comparison of FIGS. 3 and 4 also shows that in the installed state, the top 11 of the socket-shaped contact element 5 touches the face 9 of the pin-shaped contact element 4. In between, there is a switch (not shown) by way of which any axial displacement and de-contacting immediately becomes detectable. A signal obtained in this way is then transmitted to a separate switch-off device which interrupts the current path. In this way, undesirable arcs are avoided.

The re-contactable connection arrangement shown so far can be de-contacted manually.

In a further embodiment of the invention (not shown in the drawing), de-contacting is via additional de-contacting means in the form of energy storage devices. Such energy storage devices can be pyrotechnic means, spring means, pneumatic means or hydraulic means.

1. A re-contactable connection arrangement, in particular for use in motor vehicles, for connecting high-current carrying contact elements, in particular battery poles and battery terminals, characterised in that
at least one resilient connection element (2) is arranged between a socket-shaped contact element (5) and a pin-shaped contact element (4) which can be inserted into said socket-shaped contact element (5), with said resilient connection element (2) comprising a helical spring whose ends are connected so that said helical spring forms a ring.

2. The connection arrangement according to claim 1,
characterised in that the external diameter of the non-compressed resilient connection element (2) is larger than the diameter of the pin-shaped contact element (4).

3. The connection arrangement according to claim 1 or 2,
characterised in that the resilient connection element (2) is compressible in radial direction.

4. The connection arrangement according to any one of the preceding claims,
characterised in that the inside of the socket-shaped contact element (5) comprises at least one fully circumferential groove (10) into which the resilient connection element (2) can be inserted.

5. The connection arrangement according to any one of the preceding claims,
characterised in that the outside of the pin-shaped contact element (4) comprises at least one fully circumferential groove (6) into which the resilient connection element (2) can be inserted.

6. The connection arrangement according to claim 5,
characterised in that in the installed state, the groove (6) in the pin-shaped contact element (4) faces the groove (10) in the socket-shaped contact element (5).

7. The connection arrangement according to claim 6,
characterised in that the groove (6) in the pin-shaped contact element (4) and the groove (10) in the socket-shaped contact element (5) are of different depth.

8. The connection arrangement according to any one of claims 4 to 7,
characterised in that the base (7) of the groove (6, 10) is curved in cross-section.

9. The connection arrangement according to any one of claims 4 to 7,
characterised in that the base (7) of the groove (6, 10) is angular in cross-section.

10. The connection arrangement according to any one of the preceding claims,
characterised in that the pin-shaped contact element (4) is of conical shape.

11. The connection arrangement according to any one of the preceding claims,
characterised in that each winding (3) of the resilient connection element (2) in the installed state touches both the socket-shaped contact element (5) and the pin-shaped contact element (4).

12. The connection arrangement according to any one of the preceding claims,
characterised in that several resilient connection elements (2) are provided.

13. The connection arrangement according to claim 12,
characterised in that the resilient connection elements (2) are of different diameter.

14. The connection arrangement according to claim 12,
characterised in that the resilient connection elements (2) are of identical diameter.

15. The connection arrangement according to any one of the preceding claims,
characterised in that at least one sealing element, in particular a sealing ring (8), is provided between the socket-shaped contact element (5) and the pin-shaped contact element (4).

16. The connection arrangement according to any one of the preceding claims,
characterised in that a visual indicator device is provided which indicates proper seating of the contact elements (4, 5).

17. The connection arrangement according to claim 16,
characterised in that the indicator device comprises a lever connection or a button mechanism.

18. The connection arrangement according to any one of the preceding claims,
characterised in that a device for preventing an electric arc is provided.

19. The connection arrangement according to claim 18,
characterised in that a switch is provided at the top (11) of the socket-shaped contact element (5), with said switch, in the installed state, touching the face (9) of the pin-shaped contact element (4), and with axial de-contacting being able to be detected by way of said switch.

20. The connection arrangement according to claim 18,
characterised in that a high-current element, in particular a graphite ring, is provided, wherein said high-current element, in the installed state, touches one of the contact elements and consequently establishes electrical contact, and wherein axial de-contacting is detectable by way of said high-current element.

21. A resilient connection element for connecting contact elements,
characterised in that the connection element (2) is a helical spring whose ends are connected so that it forms a ring.

22. The resilient connection element according to claim 21,
characterised in that the connection element (2) is radially compressible.

23. A use of a resilient connection element (2) according to claim 21 or 22 as a retention-safeguarding element.

24. The use of a resilient connection element (2) according to claim 21 or 22 as a current transmission element.

25. A re-contactable connection arrangement according to claim 1,
characterised in that means which comprise an energy storage device are provided for de-contacting the connection.

26. The re-contactable connection arrangement according to claim 25,
characterised in that the energy storage means are pyrotechnic means.

27. The re-contactable connection arrangement according to claim 25,
characterised in that the energy storage means are spring-elastic means.

28. The re-contactable connection arrangement according to claim 25,
characterised in that the energy storage means are pneumatic means.

29. The re-contactable connection arrangement according to claim 25,
characterised in that the energy storage means are hydraulic means.
